(19) United States
(12) Patent Application Publication
(10) Pub. No.: US 2025/0286105 A1
(43) Pub. Date: Sep. 11, 2025

(54) APPARATUS AND METHOD FOR MANUFACTURING ELECTRODE ASSEMBLY AND SECONDARY BATTERY INCLUDING ELECTRODE ASSEMBLY MANUFACTURED THEREBY

(71) Applicant: SAMSUNG SDI CO., LTD., Yongin-si (KR)

(72) Inventors: Jung Ho BYEON, Yongin-si (KR); Byung Huy CHO, Yongin-si (KR); Dong Hui KIM, Yongin-si (KR)

(21) Appl. No.: 18/906,442

(22) Filed: Oct. 4, 2024

(30) Foreign Application Priority Data
Mar. 6, 2024 (KR) 10-2024-0031686

(51) Int. Cl. H01M 10/04; H01M 10/0587; H01M 50/105; H01M 50/107

(52) U.S. Cl. CPC H01M 10/0409; H01M 10/0587; H01M 50/105; H01M 50/107

(57) ABSTRACT

An electrode assembly manufacturing apparatus includes a notcher configured to notch a part of a non-coated portion of an electrode plate, such that the non-coated portion of the electrode plate includes a plurality of tab regions connected to each other by a residual non-coated portion region, the plurality of tab regions extending perpendicularly outward from a coated portion of the electrode plate regions to be between the coated portion of the electrode plate and the residual non-coated portion, a winder configured to receive the electrode plate from the notcher and to wind the electrode plate into a wound structure, and a cutter configured to receive the wound structure from the winder and to cut out the residual non-coated portion from the wound structure.

### CROSS-REFERENCE TO THE RELATED APPLICATION

The present application claims priority to and the benefit of Korean Patent Application No. 10-2024-0031686, filed on Mar. 6, 2024, in the Korean Intellectual Property Office, the entire disclosure of which is incorporated herein by reference.

### BACKGROUND

### 1. Field

Embodiments relate to an apparatus and method for manufacturing an electrode assembly capable of increasing stability and a secondary battery including an electrode assembly manufactured thereby.

### 2. Description of the Related Art

A secondary battery is a battery that can be charged and discharged, unlike a primary battery, which cannot be charged. A low-capacity battery having a single battery cell packaged in the form of a pack is used in small portable electronic devices such as a smartphone and a digital camera, and a module-type large-capacity battery including dozens or hundreds of battery packs connected to each other is widely used as a power source for driving a motor of a hybrid electric vehicle, an electric vehicle, a power tool, a handheld vacuum cleaner, or a drone, or as an energy storage system.

Based on the shape of a battery case, secondary batteries may be classified into a cylindrical battery having an electrode assembly mounted in a cylindrical metal can, a prismatic battery having an electrode assembly mounted in a prismatic metal can, and a pouch-shaped battery having an electrode assembly mounted in a cell case made of an aluminum laminate sheet. The electrode assembly of the secondary battery may be formed by winding or stacking a stack of a first electrode plate, a separator, and a second electrode plate, each of which may be formed as a thin sheet or a thin membrane.

The above information disclosed in this Background section is for enhancement of understanding of the background of the present disclosure, and therefore, it may contain information that does not constitute related (or prior) art.

### SUMMARY

An electrode assembly manufacturing apparatus according to an embodiment of the present disclosure includes a notcher configured to notch a part of a non-coated portion of an electrode plate, such that the non-coated portion of the electrode plate includes a plurality of tab regions connected to each other by a residual non-coated portion region, the plurality of tab regions extending perpendicularly outward from a coated portion of the electrode plate regions to be between the coated portion of the electrode plate and the residual non-coated portion, a winder configured to receive the electrode plate from the notcher and to wind the electrode plate into a wound structure, and a cutter configured to receive the wound structure from the winder and to cut out the residual non-coated portion from the wound structure.

The notcher may include at least one of a laser and a die configured to notch the part of the non-coated portion of the electrode plate along a notching line.

The cutter may include at least one of a laser and a die configured to cut between the residual non-coated portion region and the plurality of tab regions along a cutting line.

The winder may be between the notcher and the cutter, the cutter being configured to cut at an intersection point between the residual non-coated portion region and the plurality of tab regions.

The notcher may include one of a laser and a die, and the cutter includes another of the laser and the die.

The notcher may be configured to notch the part of the non-coated portion of the electrode plate, such that a notched shape in the non-coated portion of the electrode plate includes a circular recess that is concave toward an inside of each of the plurality of tab regions at an intersection point between the residual non-coated portion region and each of the plurality of tab regions.

The notcher may be configured to notch the part of the non-coated portion of the electrode plate, such that a notched shape in the non-coated portion of the electrode plate includes a gentle curve that is convex toward an outside of each of the plurality of tab regions at an intersection point between the residual non-coated portion region and each of the plurality of tab regions.

The notcher may be configured to notch the part of the non-coated portion of the electrode plate, such that a notched shape in the non-coated portion of the electrode plate includes an angled shape at an intersection point between the residual non-coated portion region and each of the plurality of tab regions.

The notcher may be configured to notch the part of the non-coated portion of the electrode plate, such that each of the plurality of tab regions includes a recess with a width of 0 mm to 1.5 mm.

An electrode assembly manufacturing method according to an embodiment of the present disclosure includes notching a part of a non-coated portion of each of a first electrode plate and a second electrode plate in a longitudinal direction to form a plurality of tab regions and a residual non-coated portion region connecting the plurality of tab regions to each other, such that each of the plurality of tab regions extends perpendicularly outward from a coated portion of a respective one of the first electrode plate and the second electrode plate to be between the coated portion and the residual non-coated portion, winding the first electrode plate and the second electrode plate to form a wound structure, and cutting between the plurality of tab regions and the residual non-coated portion region in the wound structure, such that only the plurality of tab regions remain in the wound structure.

The notching may include notching the part of the non-coated portion using at least one of a laser and a die, such that a notching line is formed by the at least one of the laser and die.

The cutting may include cutting between the residual non-coated portion region and the plurality of tab regions using at least one of a laser and a die, such that a cutting line is formed by the at least one of the laser and die.

The notching and the cutting may be performed by different methods, such that a notching line formed in the notching and a cutting line formed in the cutting have different shapes.

The electrode assembly manufacturing method may further include attaching an adhesive member to at least one of the plurality of tab regions of each of the first electrode plate and the second electrode plate before the winding.

The notching may include forming a notched shape in the non-coated portion of the electrode plate, such that the notched shape is between two adjacent ones of the plurality of tab regions, and a height of the residual non-coated portion region is less than or equal to a height of each of the plurality of tab regions.

A secondary battery according to an embodiment of the present disclosure includes an electrode assembly manufactured by the electrode assembly manufacturing method, the electrode assembly including a first electrode tab and a second electrode tab including the plurality of tab regions, and each of the first electrode tab and the second electrode tab includes a notched shape at opposite ends thereof, and a case accommodating the electrode assembly.

The notched shape may be at least one of an inwardly concave circular recess, an outwardly convex gentle curve, and a right angle shape.

A cutting line at an end of each of the first electrode tab and the second electrode tab and the notched shape and left and right notching lines of each of the first electrode tab and the second electrode tab may have different shapes.

Each of the first electrode tab and the second electrode tab may include at least two tabs coupled by winding the first electrode plate and the second electrode plate.

A width of the notched shape may be 0 mm to 1.5 mm.

### BRIEF DESCRIPTION OF THE DRAWINGS

The following drawings attached to this specification illustrate embodiments of

the present disclosure, and further describe aspects and features of the present disclosure together with the detailed description of the present disclosure. Thus, the present disclosure should not be construed as being limited to the drawings:

FIG. 1 is a schematic view showing an electrode assembly manufacturing apparatus according to an embodiment of the present disclosure;

FIG. 2 is a view showing a conventional notched tab electrode plate and a notched tab electrode plate formed by the electrode assembly manufacturing apparatus according to the embodiment of the present disclosure;

FIG. 3 is a view showing a notched electrode plate according to an embodiment of the present disclosure;

FIGS. 4 to 6 are views showing notching lines and notched shapes according to various embodiments;

FIGS. 7 to 9 are views showing cutting lines according to various embodiments;

FIG. 10 is a perspective view showing a secondary battery according to an embodiment of the present disclosure;

FIG. 11 is a perspective view showing a secondary battery according to another embodiment of the present disclosure; and

FIG. 12 is a sectional view of the secondary battery in FIG. 11.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an arbitrary element is referred to as being disposed (or located or positioned) on the “above (or below)” or “on (or under)” a component, it may mean that the arbitrary element is placed in contact with the upper (or lower) surface of the component and may also mean that another component may be interposed between the component and any arbitrary element disposed (or located or positioned) on (or under) the component.

In addition, it will be understood that when an element is referred to as being “coupled,” “linked” or “connected” to another element, the elements may be directly “coupled,” “linked” or “connected” to each other, or an intervening element may be present therebetween, through which the element may be “coupled,” “linked” or “connected” to another element. In addition, when a part is referred to as being “electrically coupled” to another part, the part can be directly connected to another part or an intervening part may be present therebetween such that the part and another part are indirectly connected to each other.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in this specification are intended to describe embodiments of the present disclosure and are not intended to limit the present disclosure.

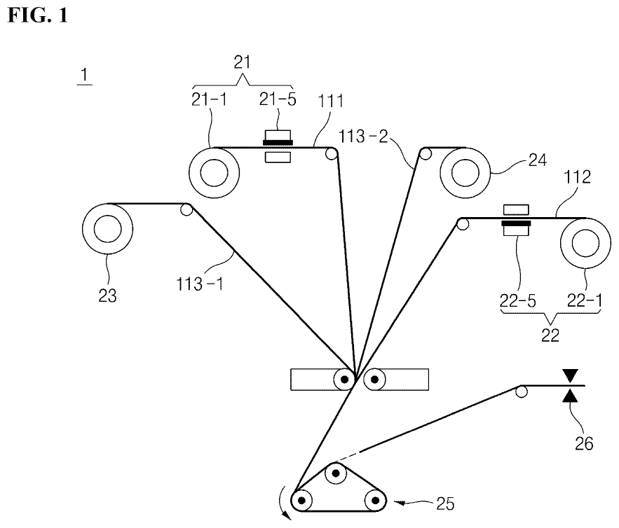

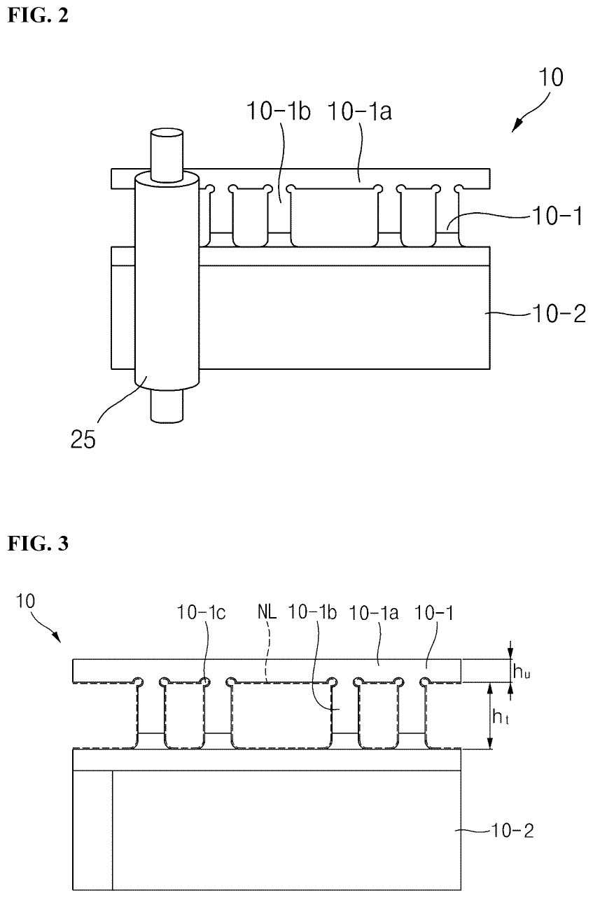

FIG. 1 is a schematic view showing an electrode assembly manufacturing apparatus 1 according to an embodiment of the present disclosure. FIG. 2 is a view showing a notched tab electrode plate formed by the electrode assembly manufacturing apparatus 1 according to the embodiment of the present disclosure.

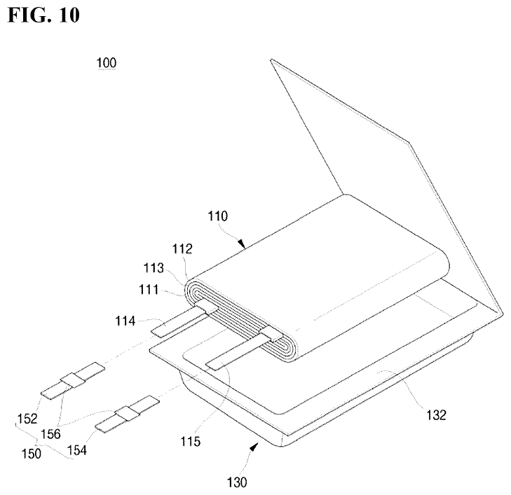

Referring to FIG. 1, the electrode assembly manufacturing apparatus 1 may include a notching unit 21-5 and 22-5 (e.g., a notcher), a winding unit 25 (e.g., a winder), and a cutting unit 26 (e.g., a cutter), and may manufacture an electrode assembly (e.g., an electrode assembly 110 in FIG. 10). The electrode assembly may include separators 113-1 and 113-2, a first electrode plate 111, and a second electrode plate 112 located (e.g., arranged) such that the separators 113-1 and 113-2 are interposed between the first and second electrode plates 111 and 112, and may be wound in a jelly-roll structure.

The electrode assembly manufacturing apparatus 1, which is configured to manufacture the electrode assembly 110 mounted in a secondary battery 100 (see FIG. 10), may include a first electrode plate supply unit 21 (e.g., a first electrode plate supplier), a second electrode plate supply unit 22 (e.g., a second electrode plate supplier), a first separator supply unit 23 (e.g., a first separator supplier), a second separator supply unit 24 (e.g., a second separator supplier), the winding unit 25, and the cutting unit 26. For example, referring to FIG. 1, the winding unit 25 may be positioned between the cutting unit 26 and the notching unit 21-5 and 22-5 (e.g., so the electrode plates and separators are wound together by the winding unit 25 before passing through the cutting unit 26).

The first electrode plate supply unit 21 may include a first reel 21-1 having a first electrode plate 111 wound therearound and configured to supply the first electrode plate 111 to the winding unit 25, and a first notching unit 21-5 configured to notch a tab at the first electrode plate 111 supplied from the first reel 21-1. For example, referring to FIG. 1, the first notching unit 21-5 may be positioned between the first reel 21-1 and the winding unit 25.

The second electrode plate supply unit 22 may include a second reel 22-1 having a second electrode plate 112 wound therearound and configured to supply the second electrode plate 112 to the winding unit 25, and a second notching unit 22-5 configured to notch a tab at the second electrode plate 112 supplied from the second reel 21-2. For example, referring to FIG. 1, the second notching unit 22-5 may be positioned between the second reel 22-1 and the winding unit 25

The first separator supply unit 23 and the second separator supply unit 24 may prevent short circuit between the first electrode plate 111 and the second electrode plate 112, and may allow only migration of lithium ions. The first separator supply unit 23 and the second separator supply unit 24 also serve to provide the separators 113-1 and 113-2, respectively, that are to be interposed between the first electrode plate 111 and the second electrode plate 112 during winding of the electrode assembly 110. Each of the first separator supply unit 23 and the second separator supply unit 24 may be in the form of a reel around which a corresponding one of the separators 113-1 and 113-2 is wound.

The winding unit 25 may be in the form of a spindle, which may wind the first electrode plate 111, the second electrode plate 112, and the separators 113-1 and 113-2 supplied from the first electrode plate supply unit 21, the second electrode plate supply unit 22, the first separator supply unit 23, and the second separator supply unit 24 to form a wound electrode assembly 110.

In an electrode assembly manufacturing method using the electrode assembly manufacturing apparatus 1, the first electrode plate 111, the second electrode plate 112, and the separators 113-1 and 113-2 may be supplied to the winding unit 25 through the first electrode plate supply unit 21, the second electrode plate supply unit 22, and the separator supply units 23 and 24, respectively. At this time, the first electrode plate supply unit 21 and the second electrode plate supply unit 22 may notch one side of non-coated portions of the first electrode plate 111 and the second electrode plate 112 at the first notching unit 21-5 and the second notching unit 22-5, respectively, to form a tab, and may supply the first electrode plate 111 and the second electrode plate 112 with the tabs to the winding unit 25. Subsequently, the winding unit 25 may be rotated (e.g., wound along the arrow in FIG. 1) to form the electrode assembly 110 including the first electrode plate 111, the second electrode plate 112, and the separators 113-1 and 113-2 interposed between the first electrode plate 111 and the second electrode plate 112. The electrode assembly 110 may be formed in a wound structure with multiple turns.

In the electrode assembly manufacturing apparatus 1 according to the embodiment, a tab may be selectively notched at a residual non-coated portion of each of a positive electrode and a negative electrode, and therefore, each of the first electrode plate 111 and the second electrode plate 112 may hereinafter be referred to as the first substrate 10 for convenience of description. The first substrate 10 may include a first non-coated portion 10-1 and a first active material layer 10-2 (FIG. 2).

In some examples, referring to FIGS. 1 and 2, the electrode assembly manufacturing apparatus 1 may produce the electrode assembly by notching the first non-coated portion 10-1 of the first substrate 10 to form a tab and winding the first substrate 10 having the tab. For example, referring to FIG. 2, the first substrate 10 having the tab (e.g., multiple tab region 10-1b connected to each other) formed at the first non-coated portion 10-1 may pass over a roller of the winding unit 25 and may move to a winding core (e.g., the winding unit 25 may include at least one roller and a winding core winding together plates or substrates received from the at least one roller).

For example, if an electrode plate were to be wound in a state of having multiple tabs protruding from a substrate, while the tabs are completely separated from each other and spaced apart from each along a non-coated portion of the substrate, the tabs could have been damaged or wrinkled by the roller during winding. As such, the damaged or wrinkled tabs could have folded or caused the electrode plate to break, thereby rendering winding complicated or impossible.

In contrast, referring to FIG. 2, the electrode assembly manufacturing apparatus 1 according to the embodiment may include a notching unit configured to provide a laser-based or die-based notched shapes between the tabs of the first non-coated portion 10-1, such that multiple tabs may be spaced apart from each along the first non-coated portion 10-1 of the first substrate 10, while also being connected to each other by a first residual non-coated portion region 10-1a. As such, stress on the tabs may be alleviated, thereby preventing or substantially minimizing damage to the tabs during winding (i.e., while the tabs of the first non-coated portion 10-1 pass over the roller of the winding unit 25).

In detail, referring to FIG. 2, during notching, the electrode assembly manufacturing apparatus 1 may leave a first residual non-coated portion region 10-1a at an upper end of the tab in a multi-tab winding structure to alleviate damage that occurs while the tab passes over the roller, and may remedy wrinkles on the electrode plate and tab folding to prevent fracture. Consequently, the electrode plate may move to the winding core of the winding unit 25, and a reliable multi-tab electrode assembly may be produced while remedying tab folding.

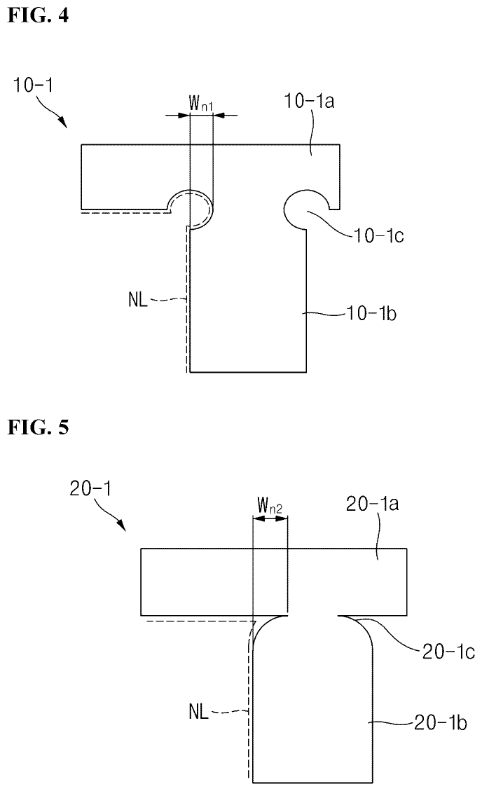

Hereinafter, notching and cutting of the first substrate 10 by the electrode assembly manufacturing apparatus 1 will be described with reference to FIGS. 3 to 9.

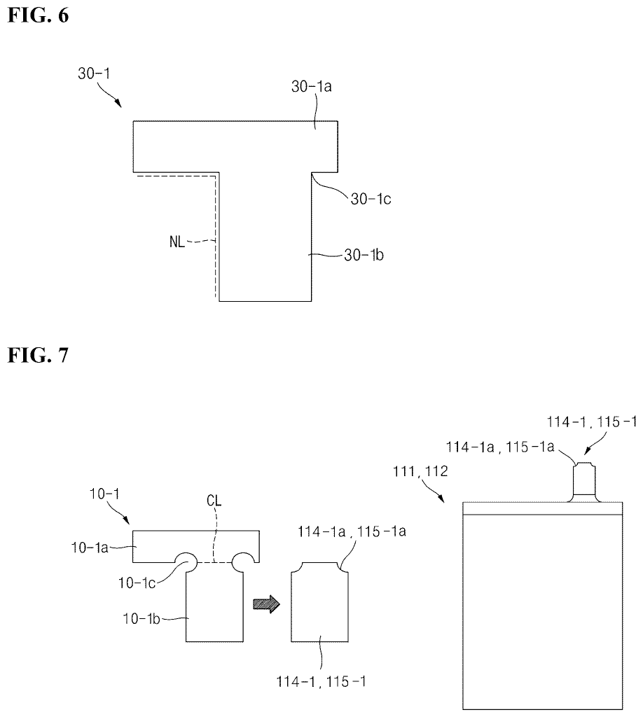

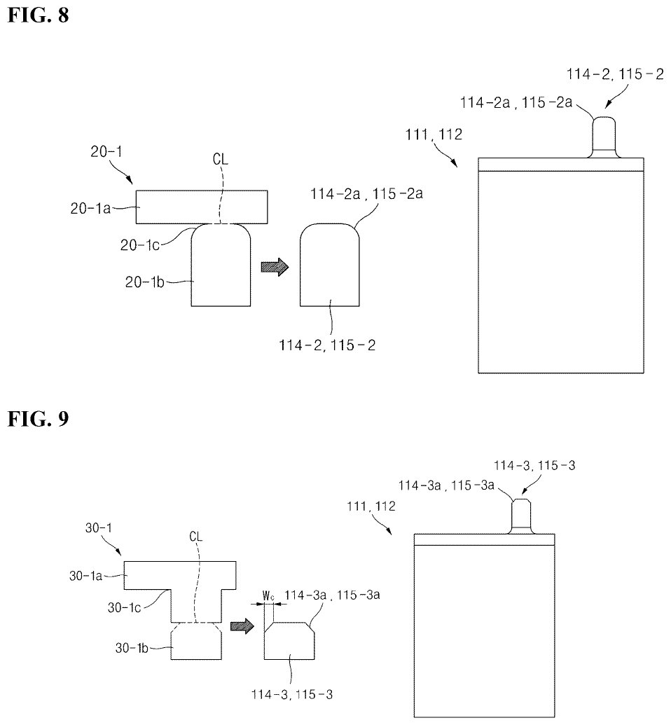

FIG. 3 is a view showing a notched electrode plate according to an embodiment of the present disclosure. FIGS. 4 to 6 are views showing notching lines and notched shapes according to various embodiments. FIGS. 7 to 9 are views showing cutting lines according to various embodiments.

Referring to FIG. 3, the notching unit 21-5 and 22-5 may notch a part of the first non-coated portion 10-1 located at one of upper and lower sides of the first substrate 10 to form a plurality of tab regions 10-1b and the first residual non-coated portion region 10-1a that connects the plurality of tab regions 10-1b to each other. For example, the plurality of tab regions 10-1b may be formed perpendicularly outward from the first non-coated portion 10-1 (e.g., the plurality of tab regions 10-1b may extend lengthwise along a direction perpendicular to a longitudinal direction of the first substrate 10 and of the first active material layer 10-2). For example, the first residual non-coated portion region 10-1a may be formed so as to connect the plurality of tab regions 10-1b to each other at upper parts of the plurality of tab regions 10-1b (e.g., the first residual non-coated portion region 10-1a may extend continuously in parallel to the longitudinal direction of the first substrate 10 to connect all the plurality of tab regions 10-1b to each other). For example, referring to FIG. 3, the first active material layer 10-2 and the first residual non-coated portion region 10-1a may be at opposite ends of each of the plurality of tab regions 10-1b along a longitudinal direction of each of the plurality of tab regions 10-1b.

In some examples, a height hu of the first residual non-coated portion region 10-1a (e.g., along the longitudinal direction of the tab regions 10-1b) may be less than or equal to the height ht of the tab region 10-1b (e.g., along the longitudinal direction of the tab regions 10-1b). The height hᵤ of the first residual non-coated portion region 10-1a may not exceed the height hₜ of the tab region 10-1b. For example, the height ht of the tab region 10-1b may be 3 mm to 22 mm.

In some examples, referring to FIG. 3, the notching unit 21-5 and 22-5 may notch a part of the first non-coated portion 10-1 using at least one of a laser and a die. Any suitable method of a laser notching method and a die notching method may be selectively used to implement the electrode plate. Consequently, a notching line NL may be formed on the first substrate 10 by notching of the notching unit 21-5 and 22-5. For example, a laser or a die may be used to remove portions of the first non-coated portion 10-1 (e.g., to remove closed shapes defined by the notching line NL in FIG. 3) to define the plurality of tab regions 10-1b.

For example, referring to FIGS. 3 and 4, the notching unit 21-5 and 22-5 may form a notched shape in the form of a circular recess that is concave toward the inside of the tab region 10-1b at an intersection point 10-1c between the first residual non-coated portion region 10-1a and the tab region 10-1b. For example, referring to FIGS. 3 and 4, the notched shape removed from the first non-coated portion 10-1 may be a rectangular shape with curved corners adjacent to the first active material layer 10-2 and concave toward the inside of the tab region 10-1b, and the circular recesses at the intersection point 10-1c between the first residual non-coated portion region 10-1a and the tab region 10-1b.

In another example, referring to FIG. 5, the notching unit 21-5 and 22-5 may form a notched shape in the form of a gentle curve that is convex toward the outside of the tab region 20-1b at an intersection point 20-1c between a residual non-coated portion region 20-1a and the tab region 20-1b. For example, referring to FIG. 5, a side of the notched shape opposite the gentle curve may include perpendicular corners.

In yet another example, referring to FIG. 6, the notching unit 21-5 and 22-5 may form a notched shape in the form of an angled shape at an intersection point 30-1c between a residual non-coated portion region 30-1a and a tab region 30-1b. A shape such as a curve may not be formed at the intersection point 30-1c.

In some examples, each of the widths Wni and Wn2 of the notched shapes of the tab regions 10-1b and 20-1b cut by the notching unit 21-5 and 22-5 may be 0 mm to 1.5 mm, e.g., larger than 0 mm and equal to or smaller than 1.5 mm. If either of the widths of the notched shapes Wₙ₁ and Wₙ₂ exceeds 1.5 mm, the tab regions 10-1b and 20-1b may be damaged during the winding process.

In some examples, the electrode assembly manufacturing apparatus 1 may wind the first substrate 10 at the winding unit 25 after forming the notched shapes on the first substrate 10 through the notching unit 21-5 and 22-5. In an embodiment, both the first electrode plate 111 and the second electrode plate 112 may be wound together while having the plurality of tab regions, whereby the first electrode plate 111 and the second electrode plate 112 may come into contact with each other. Before winding the first electrode plate 111 and the second electrode plate 112, therefore, an adhesive member may be attached to at least one of the tab region of the first electrode plate 111 and the tab region of the second electrode plate 112. In an embodiment, the negative electrode and the positive electrode may come into contact with each other at the first residual non-coated portion regions 10-1a thereof during rolling. For example, an adhesive material may be formed on the residual non-coated portion of the positive electrode.

The first electrode plate 111 and the second electrode plate 112 may be wound such that the plurality of tab regions is overlapped to form a single electrode tab. At this time, the number of turns may be set such that the number of tabs is fifty (50) or less. For example, the number of turns may be set to twenty-five (25) or less.

Referring to FIGS. 1 and 7, after winding the electrodes plates with the separators by the winding unit 25, the wound structure is transferred to the cutting unit 26 to remove the first residual non-coated portion region 10-1a from the sound structure. That is, the first residual non-coated portion region 10-1a may be removed only after the winding is complete by the winding unit 25 and the plurality of tab regions 10-1b is overlapped to form a single electrode tab.

Referring to FIG. 7, the cutting unit 26 may cut between the plurality of tab regions 10-1b and the first residual non-coated portion region 10-1a, such that only the plurality of tab regions 10-1b is left after winding the first substrate 10. The cutting unit 26 may cut the intersection point 10-1c between the first residual non-coated portion region 10-1a and the plurality of tab regions 10-1b. At this time, the intersection point 10-1c may have a notched shape in the form of a circular recess that is concave toward the inside of the tab region 10-1b. The cutting unit 26 may cut between the first residual non-coated portion region 10-1a and the plurality of tab regions 10-1b (e.g., along the dashed line in FIG. 7) using at least one of the laser and the die. Consequently, a cutting line CL may be formed on the first substrate 10 by the cutting.

Referring to FIG. 8, the cutting unit 26 may cut between the plurality of tab regions 20-1b and the residual non-coated portion region 20-1a, such that only the plurality of tab regions 20-1b is left after winding the first substrate 10. The cutting unit 26 may cut the intersection point 20-1c between the residual non-coated portion region 20-1a and the plurality of tab regions 20-1b. At this time, the intersection point 20-1c may have a notched shape in the form of a gentle curve that is convex toward the inside of the tab region 20-1b. The cutting unit 26 may cut between the residual non-coated portion region 20-1a and the plurality of tab regions 20-1b using at least one of the laser and the die. Consequently, a cutting line CL may be formed on the first substrate 10 by the cutting.

In an embodiment, the position of the cutting line CL may vary depending on the notched shape of the tab portion left after cutting of the cutting unit 26.

In an embodiment, the notching unit 21-5 and 22-5 and the cutting unit 26 may perform notching and cutting using different methods. If the notching unit 21-5 and 22-5 performs notching using the die, the cutting unit 26 may perform cutting using the laser. Consequently, the notching line NL and the cutting line CL may have different cutting shapes.

However, referring to FIG. 9, if an angled notched shape is formed at the intersection point 30-1c between the residual non-coated portion region 30-1a and the tab region 30-1b (i.e., a curved shape is not formed at the intersection point 30-1c), the cutting unit 26 may cut one side between the residual non-coated portion region 30-1a and the tab region 30-1b. At this time, the cutting unit 26 may cut one side under the intersection point 30-1c, and may form the cutting line CL in the form of an upper part of a trapezoidal shape, rather than a straight line, in order to distinguish the cutting line from the notching line NL.

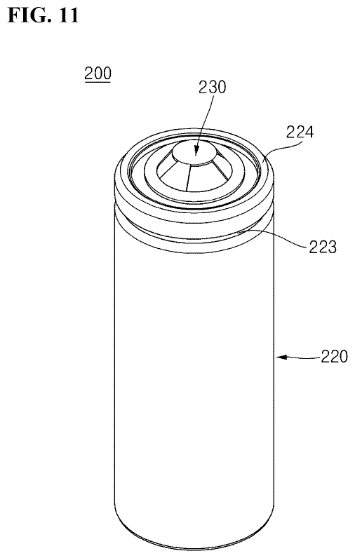

As described above, referring to FIGS. 7 and 8, the cutting unit 26 may cut between the plurality of tab regions 10-1b and 20-1b and the first residual non-coated portion regions 10-1a and 20-la, respectively, after winding the first electrode plate 111 and the second electrode plate 112 at the winding unit 25 to form a first electrode tab 114 (see FIG. 11) and a second electrode tab 115 (see FIG. 11). The shapes of end edges 114-1a, 115-1a, 114-2a, 114-2a, add 115-2a of first electrode tabs 114-1 and 114-2 and second electrode tabs 115-1 and 115-2 may be the same as the shapes of the intersection points 10-1c and 20-1c. Referring to FIG. 9, the shapes of end edges 114-3a and 115-3a of a first electrode tab 114-3 and a second electrode tab 115-3 may be the same as the shape of the cutting line CL, such as a trapezoid shape. In some examples, the width W_{c} of the cutting shape of each of the end edges 114-3a and 115-3a of the electrode tabs formed by the cutting line CL of the tab region 30-1b may be 0 mm to 1.5 mm. If the width We of the cutting shape exceeds 1.5 mm, the tab region 30-1b may be damaged during the winding process.

FIG. 10 is a perspective view showing a secondary battery according to an embodiment of the present disclosure.

Referring to FIG. 10, the secondary battery 100 may include the electrode assembly 110 and a pouch 130 configured to receive the electrode assembly 110.

In some examples, the electrode assembly 110 may be manufactured by the electrode assembly manufacturing apparatus 1, and may include the first electrode tab 114 and the second electrode tab 115 formed by notching and cutting non-coated portions of a first electrode plate 111 and a second electrode plate 112, wherein a notched shape may be formed at both ends of each of the first electrode tab 114 and the second electrode tab 115. The notched shape may be at least one of an inwardly concave circular recess, an outwardly convex gentle curve, and a right angle shape. A cutting line CL at the end of each of the first electrode tab 114 and the second electrode tab 115 and the notched shape and left and right notching lines NL of each of the first electrode tab 114 and the second electrode tab 115 may be formed in different shapes. For example, an electrode tab portion may be cut using a laser, and a residual non-coated portion region may be cut using a die such that the cutting forms (e.g., shapes) are different from each other, whereby, cutting after formation of the notched tab may be determined even if the notched shape is a right angle shape.

The electrode assembly 110 may include the first electrode plate 111 (e.g., a positive electrode plate), the second electrode plate 112 (e.g., a negative electrode plate), and a separator 113 interposed therebetween. The positive electrode plate 111 may be provided with the first electrode tab 114 (e.g., a positive electrode tab electrically connected to a positive electrode non-coated portion), and the negative electrode plate 112 may be provided with the second electrode tab 115 (e.g., a negative electrode tab electrically connected to a negative electrode non-coated portion). The first electrode tab 114 and the second electrode tab 115 may be welded to a first lead 152 (e.g.,a positive electrode lead) and a second lead 154 (e.g., a negative electrode lead) of an external terminal so as to be electrically connected to the outside. A tab film 156 for insulation from the pouch 130 may be attached to each of the first lead 152 and the second lead 154.

The first electrode plate 111 of the electrode assembly 110 may include the first substrate 10 and the first active material layer 10-2 on the first substrate 10. The first electrode tab 114 may extend outwardly from the first non-coated portion 10-1 of the first substrate 10 at where the first active material layer 10-2 is not located. The second electrode plate 112 may include a second substrate and a second active material layer on the second substrate. The second electrode tab 115 may extend outwardly from a second uncoated portion of the second substrate at where the second active material layer is not located. The formation of the second electrode tab 115 in the second uncoated portion is substantially the same as the formation of the first electrode tab 114 in the first non-coated portion 10-1, ad discussed previously with reference to FIGS. 1-9. The first electrode tab 114 and the second electrode tab 115 may extend in same directions.

The pouch 130, in which the electrode assembly 110 is received, may be sealed in the state in which sealing portions located at the edge thereof are in contact with each other. At this time, the pouch 130 may be sealed in the state in which the tab film 156 is disposed between the sealing portions 132. The form in which the tab film 156 is attached to each of the first electrode tab 114 and the second electrode tab 115 is defined as a “detachable tab film” (such a sealing structure is defined as a detachable sealing structure).

The sealing portion 132 of the pouch 130 may be made of a thermal fusion material, wherein sealing may be achieved by bonding thermal fusion layers to each other. Because the thermal fusion material generally has poor adhesion to metals, a thin film type tab film may be attached to the tab so as to be fused to the pouch 130. In the detachable sealing structure, however, the thin film type tab film must be attached to each tab, must be welded to the tab, and must be thermally fused to the pouch 130, resulting in poor workability and productivity.

However, in the present disclosure, the pouch 130 may be configured in various shapes, such as a circular shape and a pouch shape. Further, the pouch 130 may be made of a metal, such as aluminum, aluminum alloy, or nickel-plated steel, a laminated film, or plastic (e.g., in a pouch-type embodiment).

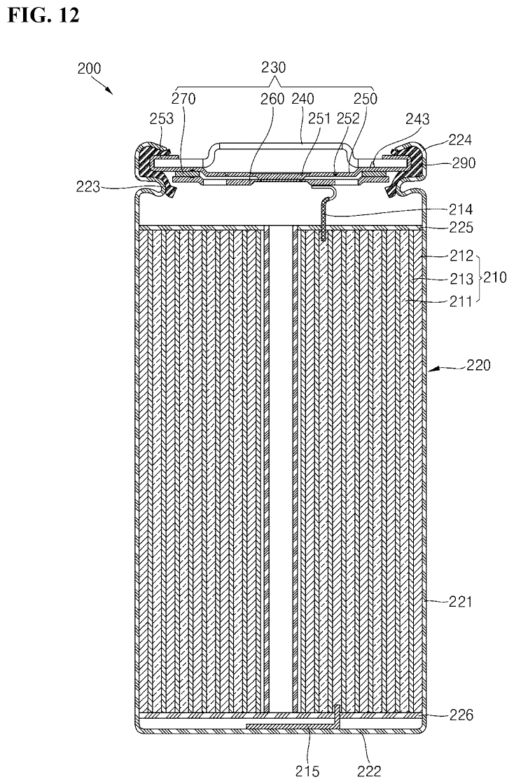

FIG. 11 is a perspective view showing a secondary battery according to another embodiment of the present disclosure. FIG. 12 is a sectional view of the secondary battery in FIG. 11.

As shown in FIGS. 11 and 12, a secondary battery 200 includes an electrode assembly 210, a case 220 accommodating the electrode assembly 210 and an electrolyte therein, a cap assembly 230 coupled to an opening of the case 220 to seal the case 220, and an insulating plate 225 positioned between the electrode assembly 210 and the cap assembly 230 inside the case 220.

The first electrode 211 of the electrode assembly 210 includes the first substrate 10 and the first active material layer 10-2 on the first substrate 10. A first lead tab 214 may extend outwardly from a first non-coated portion 10-1 of the first substrate 10 at where the first active material layer 10-2 is not located, and the first lead tab 214 may be electrically connected to the cap assembly 230.

The second electrode 212 includes a second substrate and a second active material layer on the second substrate. A second lead tab 215 may extend outwardly from a second uncoated portion of the second substrate at where the second active material layer is not located, and the second lead tab 215 may be electrically connected to the case 220. The first lead tab 214 and the second lead tab 215 may extend in opposite directions.

The first electrode 211 may act as a positive electrode. In such an embodiment, the first substrate 10 may be made of, for example, an aluminum foil, and the first active material layer may include, for example, a transition metal oxide. The second electrode 212 may act as a negative electrode. In such an embodiment, the second substrate may be made of, for example, a copper foil or a nickel foil, and the second active material layer may include graphite, for example.

The separator 213 prevents a short circuit between the first electrode 211 and the second electrode 212 while allowing movement of lithium ions therebetween. The separator 213 may be made of, for example, a polyethylene film, a polypropylene film, a polyethylene-polypropylene film, or the like.

The case 220 accommodates the electrode assembly 210 and, together with the cap assembly 230, forms the external appearance of the secondary battery 200. The case 220 may have a substantially cylindrical body portion 221 and a bottom portion 222 connected to one side (e.g., to one end) of the body portion 221. A beading part 223 (e.g., a bead) deformed inwardly may be formed in the body portion 221, and a crimping part 224 (e.g., a crimp) bent inwardly may be formed at an open end of the body portion 221.

The beading part 223 can reduce or prevent movement of the electrode assembly 210 inside the case 220 and can facilitate seating of the gasket 290 and the cap assembly 230. The crimping part 224 may firmly fix the cap assembly 230 by pressing the edge of the case against the gasket 290. The case 220 may be formed of iron plated with nickel, for example.

The cap assembly 230 may be fixed to the inside of the crimping part 224 by the gasket 290 to seal the case 220. The cap assembly 230 may include a cap up 240, a safety vent 250, a cap down 260, an insulating member 270, and a sub plate but is not limited thereto and may be modified in various ways.

The cap up 240 may be positioned at the uppermost part of the cap assembly 230. The cap up 240 may include a terminal part that protrudes upwardly and is connected to an external circuit, and an outlet for discharging gas may be arranged around the terminal part.

The safety vent 250 may be located under the cap up 240. The safety vent 250 may include a protrusion part 251 that protrudes convexly downwardly and is connected to the sub plate, and at least one notch 252 may be formed in the safety vent around the protrusion part 251.

When gas is generated due to overcharging or abnormal operation of the secondary battery 200, the protrusion part 251 is deformed upwardly by the pressure and separates from the sub plate while the safety vent 250 is cut (e.g., bursts or tears) along the notch 252. The cut safety vent 250 may prevent the secondary battery 200 from exploding by allowing for the gas to be discharged to the outside.

The cap down 260 may be below the safety vent 250. The cap down 260 may have a first opening for exposing the protrusion part 251 of the safety vent 250 and a second opening for gas discharge. The insulating member 270 may be positioned between the safety vent 250 and the cap down 260 to insulate the safety vent 250 and the cap down 260.

The insulating plates 225, 226 may be positioned to be in contact with the electrode assembly 210 below the beading part 223. The insulating plates 225, 226 may have a tab opening through which the first lead tab 214 is drawn out. The cap assembly 230, which is electrically connected to the first electrode 211 by the first lead tab 214, may face the electrode assembly 210 with an insulating plate interposed therebetween and may maintain a state of being insulated (e.g., electrically insulated) from the electrode assembly 210 by the insulating plates 225, 226.

However, the present disclosure is not limited to the above embodiment, and the case 220 may be configured in various shapes, such as a circular shape and a pouch shape. Further, the case 220 may be made of a metal, such as aluminum, aluminum alloy, or nickel-plated steel, a laminated film, or plastic (e.g., in a pouch-type embodiment).

In some embodiments, as the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be use-d.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D′_{c}(0.90≤a≤1.8, 0≤b≤0.5, 0≤c≤0.05); LiₐMn_{2-b}X_{b}O_{4-c}D′_{c} (0.90≤a≤1.8, 0≤b≤0.5, 0≤c≤0.05); LiₐNi_{1-b-c}Co_{b}X_{c}O_{2-α}D′_{α}(0.90≤a≤1.8, 0≤b≤0.5, 0≤c≤0.5, 0<α<2); LiₐNi_{1-b-c}Mn_{b}X_{c}O_{2-α}′D_{α} (0.90≤a≤1.8, 0≤b≤0.5, 0≤c≤0.5, 0<α<2); LiₐNi_{b}Co_{c}L1ₐGeO₂(0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D′ is O, F, S, P, or a combination thereof; G is Al, Cr, Mn, Fe, Mg, La, Ce, Sr, V, or a combination thereof; and L1 is Mn, Al, or a combination thereof.

A positive electrode for a lithium secondary battery may include a current collector and a positive electrode active material layer formed on the current collector.

The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ(0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based heavy antibody or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

By way of summation and review, embodiments provide an apparatus and method for manufacturing an electrode assembly that is advantageous in terms of stability by leaving a residual non-coated portion at an upper end of a tab in a multi-tab winding structure and a secondary battery manufactured using the same. That is, as is apparent from the above description, according to embodiments of the present disclosure, a residual non-coated portion is left at an upper end of a tab in a multi-tab winding structure, whereby it is possible to mitigate damage generated as the tab passes over a winding roll, to remedy wrinkles on an electrode plate and tab folding in order to prevent fracture, and therefore it is possible to improve stability of a battery.

These and other aspects and features of the present disclosure will be described in or will be apparent from the following description of embodiments of the present disclosure.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An electrode assembly manufacturing apparatus, the apparatus comprising:
a notcher configured to notch a part of a non-coated portion of an electrode plate, such that the non-coated portion of the electrode plate includes a plurality of tab regions connected to each other by a residual non-coated portion region, the plurality of tab regions extending perpendicularly outward from a coated portion of the electrode plate to be between the coated portion of the electrode plate and the residual non-coated portion;
a winder configured to receive the electrode plate from the notcher and to wind the electrode plate into a wound structure; and
a cutter configured to receive the wound structure from the winder and to cut out the residual non-coated portion from the wound structure.

2. The electrode assembly manufacturing apparatus as claimed in claim 1, wherein the notcher includes at least one of a laser and a die configured to notch the part of the non-coated portion of the electrode plate along a notching line.

3. The electrode assembly manufacturing apparatus as claimed in claim 1, wherein the cutter includes at least one of a laser and a die configured to cut between the residual non-coated portion region and the plurality of tab regions along a cutting line.

4. The electrode assembly manufacturing apparatus as claimed in claim 1, wherein the winder is between the notcher and the cutter, the cutter being configured to cut at an intersection point between the residual non-coated portion region and the plurality of tab regions.

5. The electrode assembly manufacturing apparatus as claimed in claim 1, wherein the notcher includes one of a laser and a die, and the cutter includes another of the laser and the die.

6. The electrode assembly manufacturing apparatus as claimed in claim 1, wherein the notcher is configured to notch the part of the non-coated portion of the electrode plate, such that a notched shape in the non-coated portion of the electrode plate includes a circular recess that is concave toward an inside of each of the plurality of tab regions at an intersection point between the residual non-coated portion region and each of the plurality of tab regions.

7. The electrode assembly manufacturing apparatus as claimed in claim 1, wherein the notcher is configured to notch the part of the non-coated portion of the electrode plate, such that a notched shape in the non-coated portion of the electrode plate includes a gentle curve that is convex toward an outside of each of the plurality of tab regions at an intersection point between the residual non-coated portion region and each of the plurality of tab regions.

8. The electrode assembly manufacturing apparatus as claimed in claim 1, wherein the notcher is configured to notch the part of the non-coated portion of the electrode plate, such that a notched shape in the non-coated portion of the electrode plate includes an angled shape at an intersection point between the residual non-coated portion region and each of the plurality of tab regions.

9. The electrode assembly manufacturing apparatus as claimed in claim 1, wherein the notcher is configured to notch the part of the non-coated portion of the electrode plate, such that each of the plurality of tab regions includes a recess with a width of 0 mm to 1.5 mm.

10. An electrode assembly manufacturing method, the method comprising:
notching a part of a non-coated portion of each of a first electrode plate and a second electrode plate in a longitudinal direction to form a plurality of tab regions and a residual non-coated portion region connecting the plurality of tab regions to each other, such that each of the plurality of tab regions extends perpendicularly outward from a coated portion of a respective one of the first electrode plate and the second electrode plate to be between the coated portion and the residual non-coated portion;
winding the first electrode plate and the second electrode plate to form a wound structure; and
cutting between the plurality of tab regions and the residual non-coated portion region in the wound structure, such that only the plurality of tab regions remain in the wound structure.

11. The electrode assembly manufacturing method as claimed in claim 10, wherein the notching includes notching the part of the non-coated portion using at least one of a laser and a die, such that a notching line is formed by the at least one of the laser and the die.

12. The electrode assembly manufacturing method as claimed in claim 10, wherein the cutting includes cutting between the residual non-coated portion region and the plurality of tab regions using at least one of a laser and a die, such that a cutting line is formed by the at least one of the laser and the die.

13. The electrode assembly manufacturing method as claimed in claim 10, wherein the notching and the cutting are performed by different methods, such that a notching line formed in the notching and a cutting line formed in the cutting have different shapes.

14. The electrode assembly manufacturing method as claimed in claim 10, further comprising attaching an adhesive member to at least one of the plurality of tab regions of each of the first electrode plate and the second electrode plate before the winding.

15. The electrode assembly manufacturing method as claimed in claim 10, wherein the notching includes forming a notched shape in the non-coated portion of each of the first electrode plate and the second electrode plate, such that the notched shape is between two adjacent ones of the plurality of tab regions, and a height of the residual non-coated portion region is less than or equal to a height of each of the plurality of tab regions.

16. A secondary battery, comprising:
an electrode assembly manufactured by the electrode assembly manufacturing method as claimed in claim 10, the electrode assembly including a first electrode tab and a second electrode tab including the plurality of tab regions, and each of the first electrode tab and the second electrode tab includes a notched shape at opposite ends thereof, and
a case accommodating the electrode assembly.

17. The secondary battery as claimed in claim 16, wherein the notched shape is at least one of an inwardly concave circular recess, an outwardly convex gentle curve, and a right angle shape.

18. The secondary battery as claimed in claim 16, wherein a cutting line at an end of each of the first electrode tab and the second electrode tab and the notched shape and left and right notching lines of each of the first electrode tab and the second electrode tab have different shapes.

19. The secondary battery as claimed in claim 16, wherein each of the first electrode tab and the second electrode tab includes at least two tabs coupled by winding the first electrode plate and the second electrode plate.

20. The secondary battery as claimed in claim 16, wherein a width of the notched shape is 0 mm to 1.5 mm.
